(19) United States
(12) Patent Application Publication
(10) Pub. No.: US 2024/0147311 A1
(43) Pub. Date: May 2, 2024

(54) TECHNIQUES TO FACILITATE NETWORK SLICE-BASED RESELECTION USING MACHINE LEARNING

(71) Applicant: QUALCOMM Incorporated, San Diego, CA (US)

(72) Inventors: Kuo-Chun LEE, San Diego, CA (US); Vishal DALMIYA, San Diego, CA (US); Arvind Vardarajan SANTHANAM, San Diego, CA (US); Shanshan WANG, San Diego, CA (US); Leena ZACHARIAS, San Jose, CA (US); Vaishakh RAO, San Diego, CA (US); Tom CHIN, San Diego, CA (US)

(21) Appl. No.: 18/052,183

(22) Filed: Nov. 2, 2022

(51) Int. Cl. H04W 36/00; H04W 24/08; H04W 36/14; H04W 76/30

(52) U.S. Cl. CPC H04W 36/0027; H04W 24/08; H04W 36/14; H04W 76/30

(57) ABSTRACT

Apparatus, methods, and computer-readable media for facilitating network slice based reselection using machine learning are disclosed herein. An example method for wireless communication at a UE includes predicting a next active PDU session of two or more PDU sessions based on next connection setup times for each PDU session. The next connection setup times may be estimated based on connection setup events occurring over a period. The example method also includes selecting a frequency channel to camp on based on the next active PDU session.

### TECHNICAL FIELD

The present disclosure relates generally to communication systems, and more particularly, to wireless communication employing multiple protocol data unit (PDU) sessions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus predict a next active protocol data unit (PDU) session of two or more PDU sessions based on next connection setup times for each PDU session. The next connection setup times may be estimated based on connection setup events occurring over a period. The example apparatus may also select a frequency channel to camp on based on the next active PDU session

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and a UE in an access network.

FIG. 4 illustrates a conceptual diagram of network slicing for a network, in accordance with various aspects of the present disclosure.

FIG. 5 illustrates a diagram including a UE in communication with a first cell and a second cell, in accordance with various aspects of the present disclosure.

FIG. 6 illustrates a timing diagram including a UE with multiple established PDU sessions, in accordance with various aspects of the present disclosure.

FIG. 7 illustrates a timing diagram in which a UE may predict a next connection setup event is associated with a PDU session based on past connection setup events, in accordance with various aspects of the present disclosure.

FIG. 8 illustrates an example of a prediction procedure applied by a UE based on a time sequence of connection setup events, in accordance with various aspects of the present disclosure.

FIG. 9 depicts a timing diagram illustrating predictions of next connection setup events by a UE, in accordance with various aspects of the present disclosure.

FIG. 10 illustrates an example of a prediction procedure applied by a UE based on a smaller set of input data, in accordance with various aspects of the present disclosure.

FIG. 11 depicts an example timing diagram in which the next active PDU session is selected based on priority and a delta threshold, in accordance with various aspects of the present disclosure.

FIG. 12 illustrates an example communication flow between a network entity and a UE, in accordance with various aspects of the present disclosure.

FIG. 13 is a flowchart of a method of wireless communication at a UE, in accordance with the teachings disclosed herein.

FIG. 14 is a flowchart of a method of wireless communication at a UE, in accordance with the teachings disclosed herein.

FIG. 15 is a diagram illustrating an example of a hardware implementation for an example apparatus and/or network entity.

### DETAILED DESCRIPTION

In some aspects, a UE may simultaneously be served by one or more network slice instances via a network. In some aspects, a network operator may allocate one frequency channel that is best suitable for one network slice instance and may allocate another frequency channel that is best suitable for a different network slice instance. For example, frequency channel 1 may be best suitable for an eMBB network slice instance, and frequency channel 2 may be best suitable for a URLLC network slice instance. In some examples, the UE may be configured with network slice information that provides information regarding different network slice instances available to the UE.

In some examples, the UE may be configured to perform cell reselection. For example, while in an idle mode or an inactive mode, the UE may determine to connect to a new cell, for example, due to movement of the UE, a change in channel conditions, etc. In some examples, the UE may use a frequency channel to prioritize when performing a cell reselection procedure based on network slicing.

In examples disclosed herein, when a UE registers with a network, the UE may establish a PDU session to communicate data to and from the network. The UE may establish the PDU session with a particular network slice instance. A PDU session may belong to one specific network slice instance per network. For example, the UE may establish a first PDU session and associate a first network slice instance with the first PDU session. In examples in which the UE is performing a cell reselection procedure in association with the first PDU session, the UE may prioritize the frequency channel supporting the first network slice instance associated with the first PDU session.

However, in some scenarios, a UE may establish two or more PDU sessions and each PDU session may be associated with a different respective network slice instance. In some such scenarios, it may be beneficial to enable the UE to determine which frequency channel to prioritize when performing a cell reselection procedure as each network slice instance may be associated with different frequency channels and respective reselection priorities.

Aspects presented herein may enable a UE to predict a next active PDU session and to switch to a corresponding frequency channel to camp on while in an idle/inactive mode. Such aspects may improve communication performance, for example, by reducing delays and/or service disruptions associated with changing to the frequency channel when a connection setup is requested. Aspects disclosed herein enable a UE to prioritize a frequency channel when performing a cell reselection procedure based on past connection setup events for all established PDU sessions. For example, the UE may monitor connection setup events over a period and predict, based on the past connection setup events, which of the established PDU sessions will request a next connection setup. The UE may then select a frequency channel to prioritize when performing a cell reselection procedure based on the prediction.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

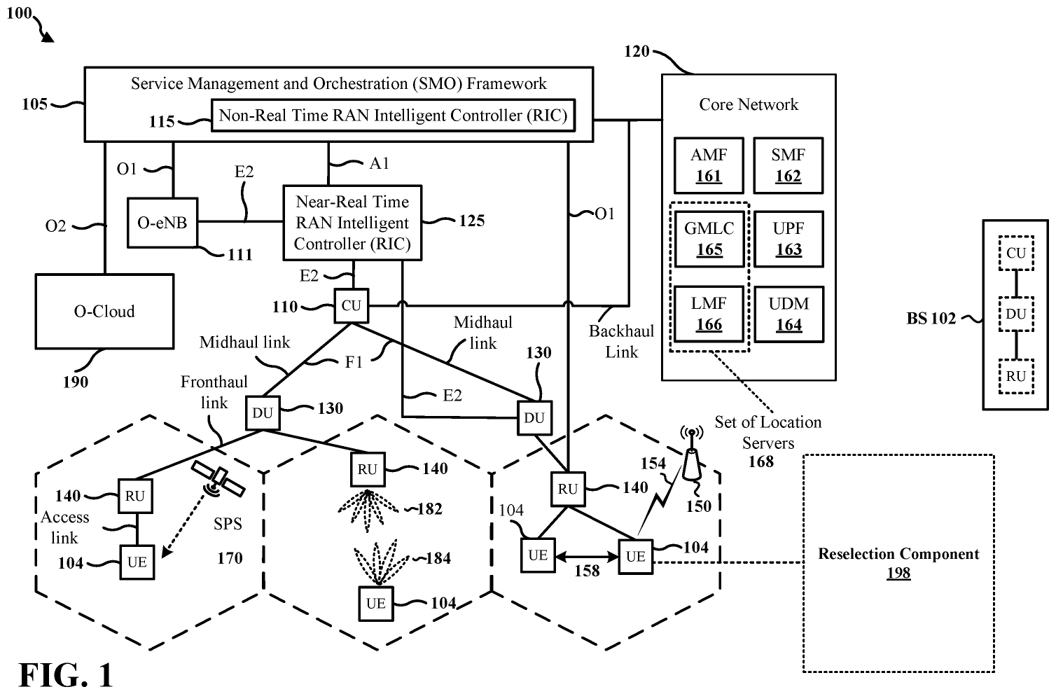

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUs (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as a UE 104 in communication with a network entity, such as a base station 102 or a component of a base station (e.g., a CU 110, a DU 130, and/or an RU 140), may be configured to manage one or more aspects of wireless communication. For example, the UE 104 may include a reselection component 198 configured to facilitate predicting a next active PDU session to select a frequency channel to camp on while in an idle mode or an inactive mode.

In certain aspects, the reselection component 198 may be configured to predict a next active PDU session of two or more PDU sessions based on next connection setup times for each PDU session. The next connection setup times may be estimated based on connection setup events occurring over a period. The example reselection component 198 may also be configured to select a frequency channel to camp on based on the next active PDU session.

The aspects presented herein may enable a UE to predict a next active PDU session and to switch to a corresponding frequency channel to camp on, which may facilitate improving communication performance, for example, by reducing delays and/or service disruptions associated with changing to the frequency channel when a connection setup is requested.

Although the following description provides examples directed to 5G NR (and, in particular, to network slice based reselection), the concepts described herein may be applicable to other similar areas, such as 5G-advanced, 6G, LTE, LTE-A, CDMA, GSM, and/or other wireless technologies, in which a UE may perform cell reselection after establishing two or more PDU sessions with respective network slices and frequency channel priorities.

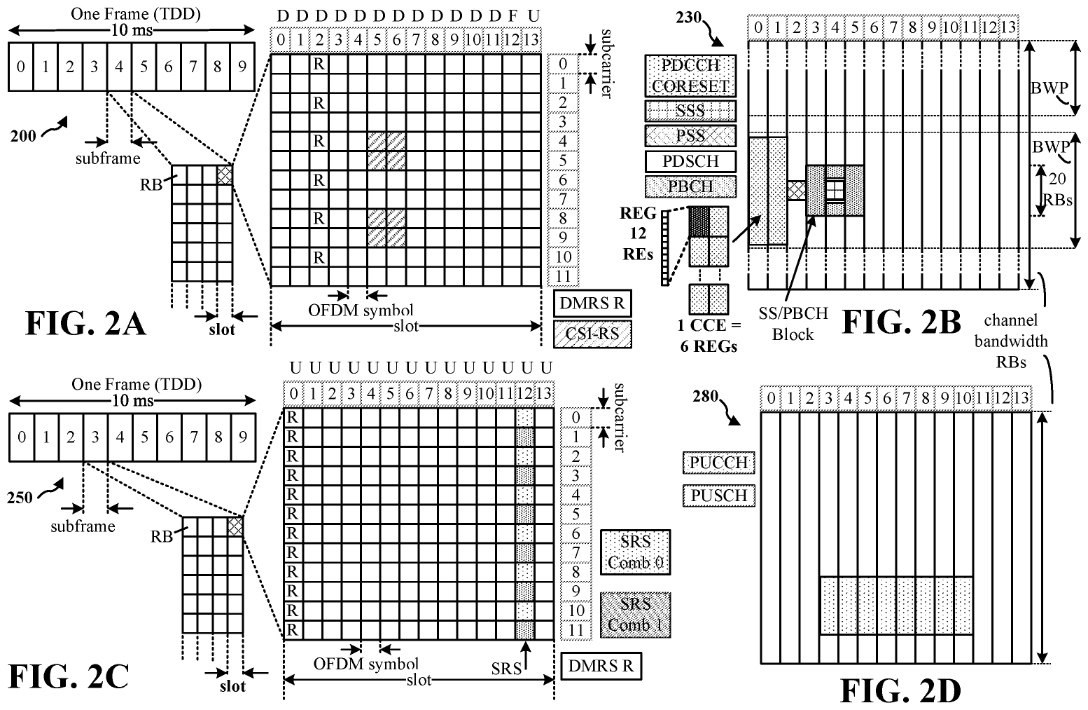

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2μ*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

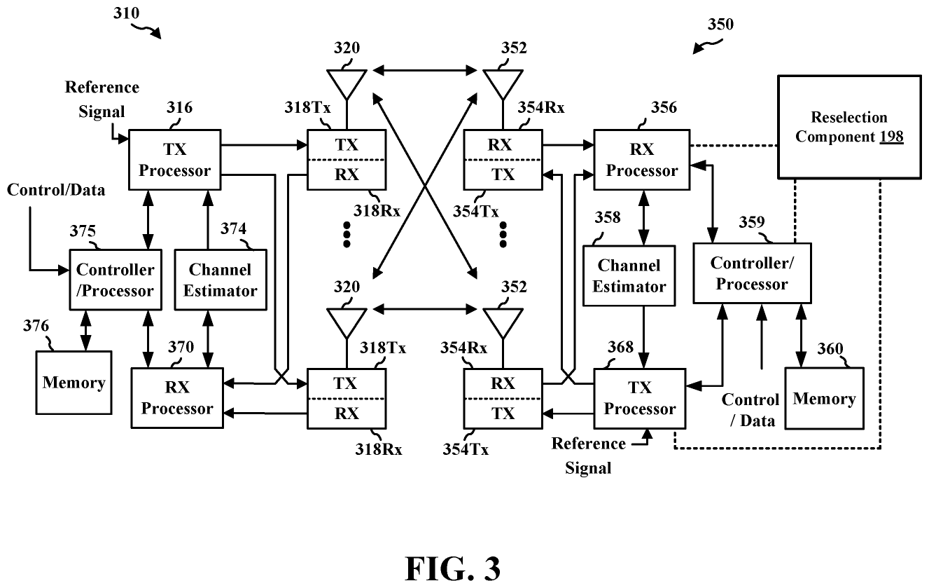

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TB s, demultiplexing of MAC SDUs from TB s, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reselection component 198 of FIG. 1.

Some aspects of wireless communication may utilize a network slicing feature. Network slicing is a type of a network architecture that may enable the multiplexing of independent logical networks on a physical network infrastructure. For example, each network slice may be an isolated end-to-end network that may fulfill specifications requested by an application. Network slicing may provide a means for a UE and a network (e.g., a network entity, such as a base station, and/or a component of a base station) to negotiate a specific type of service, which may be part of an expected set of specifications for the UE and the network. For example, a network slice may serve a particular service type with a set service level agreement (SLA).

Additionally, network slices may differ for different types of supported features and/or network function optimizations. For example, each slice may define a composition of configured network functions, network applications, and underlying cloud infrastructures that are bundled together to meet the requirements of a specific use case or business model. A multi-slice network may support multiple network slices including an eMBB slice, a URLLC slice, a massive Internet of Things (MIoT) slice, an mMTC slice, and/or a slice for any other suitable service. As an example, NR access may support various communication services, such an eMBB services targeting wide bandwidth (e.g., 80 MHz or beyond), millimeter wave (mmW) services targeting high carrier frequency (e.g., 25 GHz or beyond), mMTC services targeting non-backward compatible MTC techniques, and/or mission critical services targeting URLLC communications. These services may include latency and reliability requirements. These services may also have different transmission time intervals (TTI) to meet respective quality of service (QoS) requirements. In addition, these services may co-exist in a same subframe.

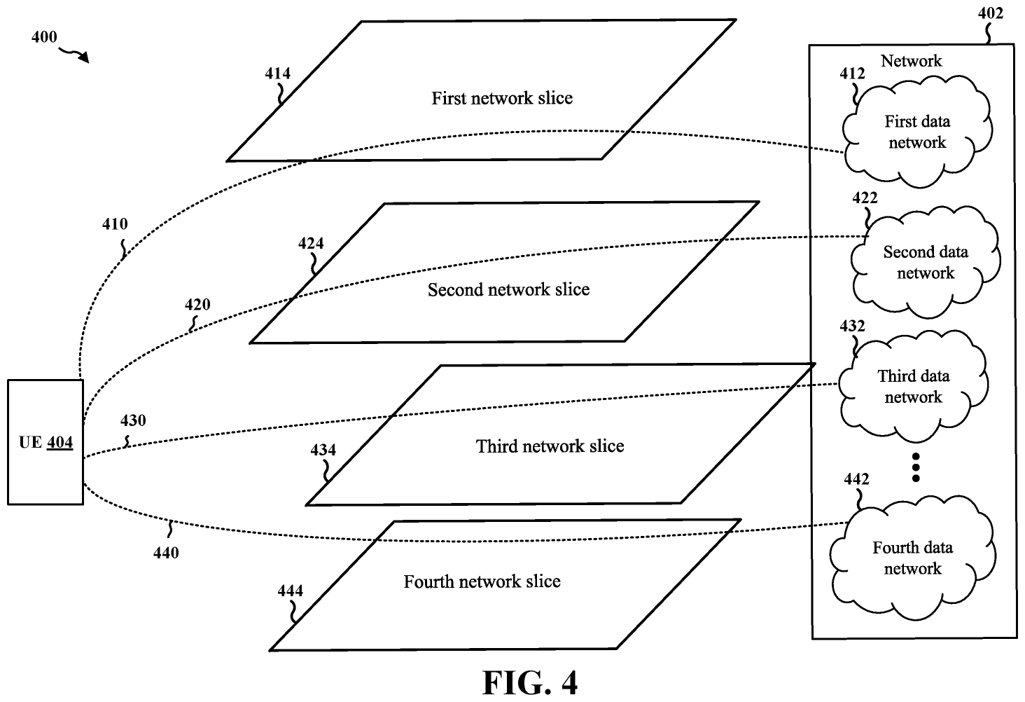

FIG. 4 illustrates a conceptual diagram of network slicing 400 for a network 402, as presented herein. A network slice may be defined within the network 402, such as a public land mobile network (PLMN). In the illustrated example of FIG. 4, various applications at a UE 404 may exchange communication with the network 402 and, more particular, to different data networks. For example, a first application may exchange first communication 410 with a first data network 412, a second application may exchange second communication 420 with a second data network 422, a third application may exchange third communication 430 with a third data network 432, and a fourth application may exchange fourth communication 440 with a fourth data network 442. Examples of the data networks includes an internet data network, an IP multimedia system (IMS) data network, an administrative data network, etc.

As shown in FIG. 4, the UE 404 may use different network slices for exchanging the communications of the different applications with the different data networks. For example, the UE 404 may use a first network slice instance 414 for the first communication 410, may use a second network slice instance 424 for the second communication 420, may use a third network slice instance 434 for the third communication 430, and may use a fourth network slice instance 444 for the fourth communication 440.

In some aspects, a UE may simultaneously be served by one or more network slice instances via an access network, such as a 5G access network (5G-AN). A network entity, such as the AMF 161 of FIG. 1, that is serving the UE may belong to each of the network slice instances serving the UE. That is, an AMF instance may be common to the network slice instances that are serving a UE. Identification of a network slice instance may be performed via a Single Network Slice Selection Assistance Information (S-NSSAI).

In some aspects, a network operator may allocate one frequency channel that is best suitable for one network slice instance (e.g., a S-NSSAI=1) and may allocate another frequency channel that is best suitable for a different network slice instance (e.g., a 5-NSSAI=2). For example, frequency channel 1 may be best suitable for an eMBB network slice instance (e.g., a S-NSSAI=1), and frequency channel 2 may be best suitable for a URLLC network slice instance (e.g., a S-NSSAI=2). As used herein, a “frequency channel” may also be referred to as an Absolute Radio Frequency Channel Number (ARFCN). For example, the frequency channel 1 may also be referred to as “ARFCN1” herein.

In some examples, the UE may be configured with network slice information that provides information regarding different network slice instances available to the UE. For example, the network slice information may include a collection of S-NSSAIs. The network slice information may be referred to as Network Slice Selection Assistance Information (NSSAI), may be referred to as “FreqPriorityListSlicing,” or by any other suitable name. Each S-NSSAI may include a slice/service type (SST) that refers to the expected network slice behavior in terms of features and services. The S-NSSAI may also include a slice differentiator (SD), which may include optional information that complements the SSTs and may be used to differentiate amongst multiple network slice instances of the same SST.

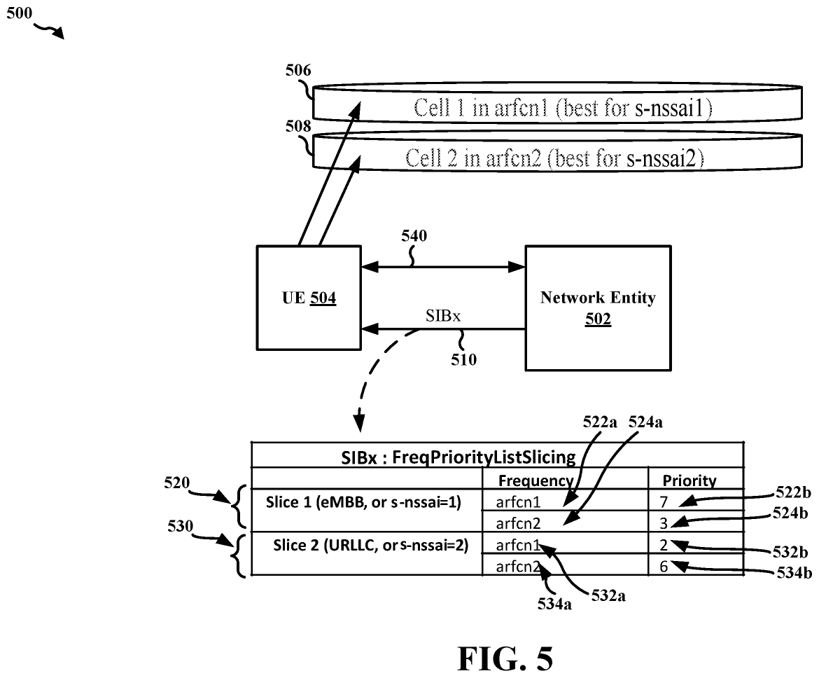

FIG. 5 illustrates a diagram 500 including a UE 504 in communication with a first cell 506 and a second cell 508, as presented herein. In the illustrated example of FIG. 5, a network entity 502 outputs (e.g., transmits) network slice information 510 that is received by the UE 504. The network entity 502 may output the network slice information 510 via a System Information Block (SIB), such as SIB16 or, more generally, SIBx. In the illustrated example of FIG. 5, the network slice information 510 (e.g., “SIBx: FreqPriorityListSlicing”) identifies a first network slice instance 520 (“Slice 1”), which may also be referred to as an “eMBB” slice or S-NSSAI=1. The network slice information 510 also identifies a second network slice instance 530 (“Slice 2”), which may also be referred to as a “URLLC” slice or S-NSSAI=2. The first network slice instance 520 is associated with a first frequency channel 522a (“arfcn1”) and a second frequency channel 524a (“arfcn2”). The second network slice instance 530 is associated with a third frequency channel 532a (“arfcn1”) and a fourth frequency channel 534a (“arfcn2”). Although the network slice information 510 of FIG. 5 includes two example network slice instances, in other examples, the network slice information may include any suitable quantity of network slice instances. Additionally, although the example network slice instances of FIG. 5 each indicate two frequency channels, in other examples, a network slice instance may indicate any suitable quantity of frequency channels. For example, one network slice instance may indicate two frequency channels while another network slice instance may indicate three frequency channels.

In the illustrated example of FIG. 5, the UE 504 is in communication with the first cell 506 (“Cell 1”) and the second cell 508 (“Cell 2”). As shown in FIG. 5, the first cell 506 is associated with the first network slice instance 520 (e.g., “s-nssai1”) and the second cell 508 is associated with the second network slice instance 530 (e.g., “s-nssai2”). Additionally, based on the cell and the network slice instance, the UE 504 may be configured to communicate via a respective frequency channel. For example, when communicating in the first cell 506, the UE 504 may use the first frequency channel 522a (“arfcn1”) as the first frequency channel 522a may be the best suitable frequency channel for the first network slice instance 520. Additionally, when communicating in the second cell 508, the UE 504 may use the fourth frequency channel 534a (“arfcn2”) as the fourth frequency channel 534a may be the best suitable frequency channel for the second network slice instance 530.

In some examples, the UE 504 may be configured to perform cell reselection. For example, while in an idle mode or an inactive mode, the UE 504 may determine to connect to a new cell, for example, due to movement of the UE 504, a change in channel conditions, etc. In some examples, the UE 504 may use a frequency channel to prioritize when performing a cell reselection procedure based on network slicing.

For example, in the illustrated example of FIG. 5, the network slice information 510 indicates a reselection priority level associated with each frequency channel of a network slice instance. For example, with respect to the frequency channels of the first network slice instance 520, the first frequency channel 522a (“arfcn1”) has a first reselection priority 522b of “7” and the second frequency channel 524a (“arfcn2”) has a second reselection priority 524b of “3.” Additionally, with respect to the frequency channels of the second network slice instance 530, the third frequency channel 532a (“arfcn1”) has a third reselection priority 532b of “2” and the fourth frequency channel 534a (“arfcn2”) has a fourth reselection priority 534b of “6.” In some examples, a larger value may be associated with a higher priority. For example, the reselection priority values may range from 0 to 7, with a reselection priority value of “0” being the lowest priority and a reselection priority level of “7” being the highest priority. Thus, in the example of FIG. 5, the first frequency channel 522a has the highest reselection priority of the frequency channels associated with the first network slice instance 520. For example, if the UE 504 performs cell reselection to the first cell 506, the UE 504 may select the first frequency channel 522a to camp on while in an idle/inactive mode. Additionally, the fourth frequency channel 534a has the highest reselection priority of the frequency channels associated with the second network slice instance 530. For example, if the UE 504 performs cell reselection to the second cell 508, the UE 504 may select the fourth frequency channel 534a to camp on while in an idle/inactive mode.

In examples disclosed herein, when a UE registers with a network, the UE may establish a protocol data unit (PDU) session to communicate data to and from the network. The UE may establish the PDU session with a particular network slice instance (e.g., a specific S-NSSAI). A PDU session may belong to one specific network slice instance per network, such as a public land mobile network (PLMN). Also, different network slice instances may not share a PDU session.

For example, the UE 504 may establish a first PDU session 540. The UE 504 may also associate the first network slice instance 520 with the first PDU session 540. In examples in which the UE 504 is performing a cell reselection procedure in association with the first PDU session 540, the UE 504 may prioritize the frequency channel supporting the first network slice instance 520 associated with the first PDU session 540. For example, with respect to the first network slice instance 520, the first frequency channel 522a has a higher reselection priority value than the second frequency channel 524a and, thus, may prioritize the first frequency channel 522a when performing the cell reselection procedure.

However, in some scenarios, a UE may establish two or more PDU sessions and each PDU session may be associated with a different respective network slice instance. In some such scenarios, it may be beneficial to enable the UE to determine which frequency channel to prioritize when performing a cell reselection procedure as each network slice instance may be associated with different frequency channels and respective reselection priorities.

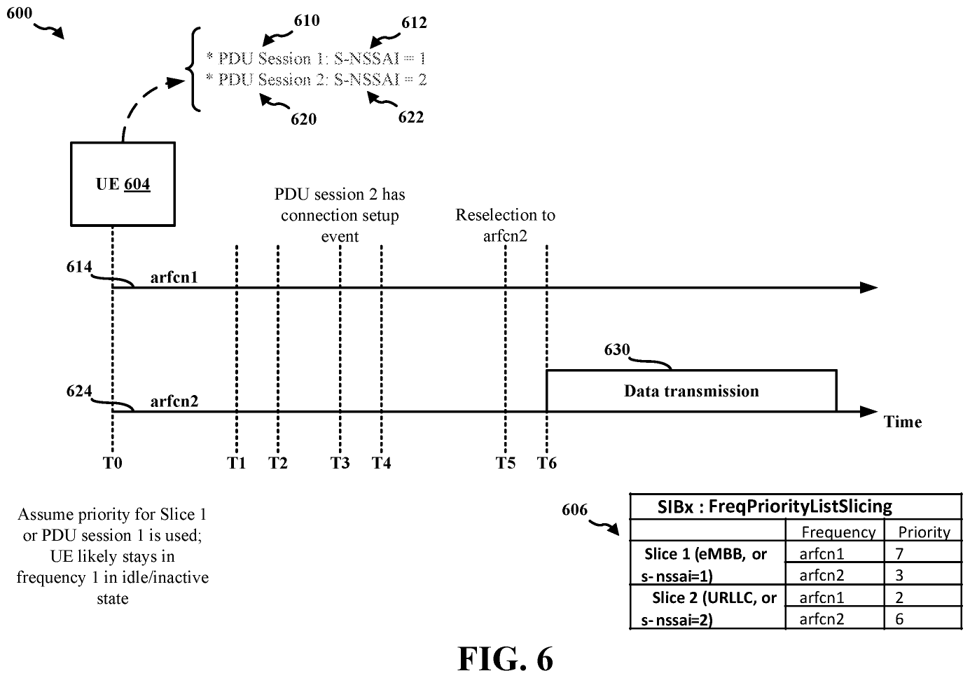

FIG. 6 illustrates a timing diagram 600 including a UE 604 with multiple established PDU sessions, as presented herein. For example, the UE 604 may establish a first PDU session 610 (“PDU Session 1”) that is associated with a first network slice instance 612 (“S-NSSAI=1”). The UE 604 may also establish a second PDU session 620 (“PDU Session 2”) that is associated with a second network slice 622 (“S-NSSAI=2”). The UE 604 may select the network slice instance associated with the respective PDU session based on network slice information 606. The UE 504 may be configured with the network slice information 606, for example, via a SIBx. Aspects of the network slice information 606, the first network slice instance 612, and the second network slice 622 may be similar to the network slice information 510, the first network slice instance 520, and the second network slice instance 530, respectively, of FIG. 5.

As shown in FIG. 6, and based on the network slice information 606, a first frequency channel 614 (“arfcn1”) is the prioritized frequency channel for the first network slice instance 612 when the UE 604 performs a cell reselection procedure to a cell associated with the first PDU session 610. Additionally, a second frequency channel 624 (“arfcn2”) is the prioritized frequency channel for the second network slice 622 when the UE 604 performs a cell reselection procedure to a cell associated with the second PDU session 620.

In the illustrated example of FIG. 6, the UE 604 is in an idle/inactive mode at time T0. Additionally, at time T0, the UE 604 prioritizes the frequency channel associated with the first PDU session 610 or the first network slice instance 612. For example, the UE 604 may be configured to operate at the first frequency channel 614 based on the frequency channel prioritized for the first network slice instance 612. The UE 604 may then, at time T3, perform a connection setup event for the second PDU session 620. For example, a URLLC application of the UE 604 may provide URLLC data for the UE 604 to transmit, for example, via the second network slice 622 and the second PDU session 620. The UE 604 may perform a frequency change at time T5 to the second frequency channel 624 associated with the second network slice 622. After performing the frequency change at time T5, the UE 604 may start a data transmission 630 associated with the URLLC data at time T6.

As shown in FIG. 6, there is a delay between when the UE 604 performs the connections setup event for the second PDU session 620, at time T3, and when the UE 604 starts the data transmission 630 at time T6. Additionally, in some examples, the UE 604 may skip performing the frequency change at time T5. In some such examples, the UE 604 may suffer reduced performance.

Aspects presented herein may enable a UE to predict a next active PDU session and to switch to a corresponding frequency channel to camp on while in an idle/inactive mode. Such aspects may improve communication performance, for example, by reducing delays and/or service disruptions associated with changing to the frequency channel when a connection setup is requested. For example, in the illustrated example of FIG. 6, the UE 604 may predict, at time T1, that the next active PDU session will be the second PDU session 620. In such examples, the UE 604 may perform a frequency change at time T2, instead of waiting for a connection setup event to perform the frequency change at time T5. Thus, the UE 604 may start the data transmission associated with the connection setup event (e.g., at time T3) at an earlier time. For example, the UE 604 may start the data transmission at time T4 instead of at time T6.

In some aspects, when a PDU session is established between a UE and a network, the PDU session may remain in a connected state. For example, the UE 604 may establish the first PDU session 610 to facilitate data communication associated with an eMBB application of the UE 604. In some such examples, the UE 604 may associate the first network slice instance 612 (e.g., an eMBB slice) with the first PDU session 610 and, thus, eMBB traffic may be communicated between the UE 604 and the network via the first PDU session 610.

However, to conserve resources, for example, at the UE 604, when there is no data for transmission to the UE or from the UE, a connection associated with the PDU session between the UE and the network may be released. The UE or the network may then request a connection setup when data associated with the PDU session becomes available for transmission. For example, while operating in an idle/inactive mode, the UE 604 may receive eMBB data from the eMBB application for transmission via the first PDU session 610. The UE 604 may request a connection setup with the network and transmit the eMBB data after completing a connection setup procedure. The UE 604 may then perform a connection release procedure to release the connection associated with the PDU session, for example, after a period of inactivity. The UE 604 may also transition back to the idle/inactive mode.

Aspects disclosed herein enable a UE to prioritize a frequency channel when performing a cell reselection procedure based on past connection setup events for all established PDU sessions. For example, the UE may monitor connection setup events over a period and predict, based on the past connection setup events, which of the established PDU sessions will request a next connection setup. The UE may then select a frequency channel to prioritize when performing a cell reselection procedure based on the prediction.

For example, the UE may establish N PDU sessions, where N is an integer greater than two. The UE may log connection setup events for all of the N PDU sessions over a period L. While operating in an idle/inactive mode, the UE may perform a prediction procedure to predict a PDU session of the N PDU sessions that is going to be associated with the next connection setup event. For example, based on the logged connection setup events over the period L, the UE may predict a PDU session K to be the next active PDU session. In such scenarios, the UE may use the network slice information associated with the PDU session K to determine which frequency channel to prioritize when performing a cell reselection procedure.

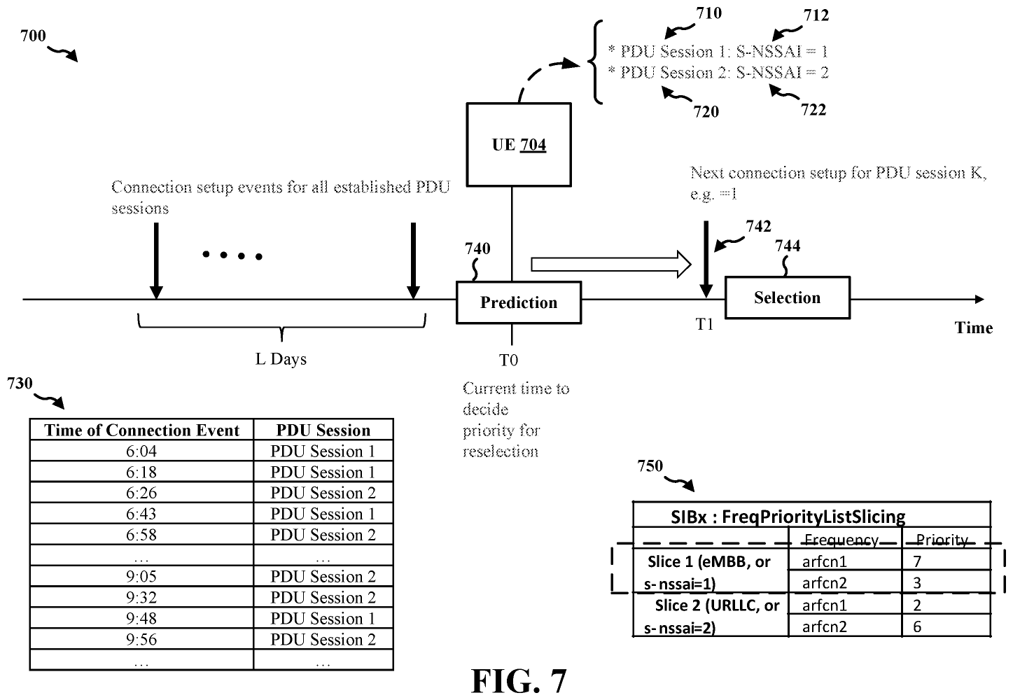

FIG. 7 illustrates a timing diagram 700 in which a UE 704 may predict a next connection setup event is associated with a PDU session K based on past connection setup events, as presented herein. In the illustrated example of FIG. 7, the UE 704 has established a first PDU session 710 and a second PDU session 720. The first PDU session 710 is associated with a first network slice instance 712 (“S-NSSAI=1”) and the second PDU session 720 is associated with a second network slice instance 722 (“S-NSSAI=2”). The UE 704 may select the network slice instance associated with the respective PDU session based on network slice information 750. The UE 704 may be configured with the network slice information 750, for example, via a SIBx. Aspects of the network slice information 750, the first network slice instance 712, and the second network slice instance 722 may be similar to the network slice information 510, the first network slice instance 520, and the second network slice instance 530, respectively, of FIG. 5.

As shown in FIG. 7, the UE 704 may perform a plurality of connection setup events for all established PDU sessions over a period, such as L days. In some examples, the UE 704 may generate a log 730 based on the connection setup events over the period. For example, the log 730 may include a time sequence of connection setups for all of the established PDU sessions (e.g., the first PDU session 710 and the second PDU session 720) over the period.

At time T0, the UE 704 may perform a prediction procedure 740 to decide a frequency channel to prioritize when performing a cell reselection procedure. The UE 704 may perform the prediction procedure 740, at time TO, when the UE 704 releases a connection. In some examples, the UE 704 may perform the prediction procedure 740 when performing a cell change. Additionally, or alternatively, the UE 704 may periodically perform the prediction procedure 740.

The UE 704 may perform the prediction procedure 740 based on the entries recorded in the log 730. For example, based on the connection setup event times listed in the log 730 and the current time (e.g., at time TO), the UE 704 may predict a next connection setup event 742 at time T1. The UE 704 may also determine that the next connection setup event 742 is associated with the first PDU session 710 (e.g., the PDU session K=1). In some such examples, the UE 704 may perform a selection procedure 744 and use the network slice information 750 to select a frequency channel to prioritize, for example, when performing a cell reselection procedure. For example, the first PDU session 710 is associated with the first network slice instance 712 and, based on the network slice information 750, the frequency channel with the highest reselection priority level is a frequency channel 1 (“arfcn1”). Thus, the UE 704 may select, via the selection procedure 744, the frequency channel 1 when performing the cell reselection procedure.

In some examples, the UE 704 may use a prediction algorithm to perform the prediction procedure 740. In some aspects, the prediction algorithm may be implemented via machine learning and/or a classifier algorithm.

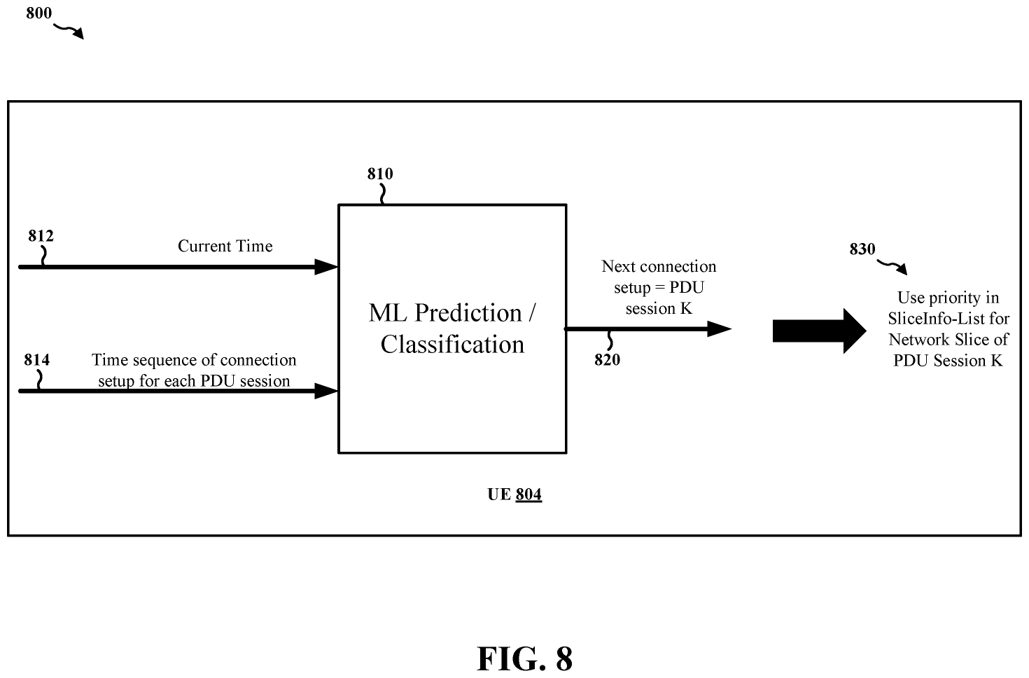

FIG. 8 illustrates an example of a prediction procedure 800 applied by a UE 804 based on a time sequence of connection setup events, as presented herein. In the example of FIG. 8, a prediction component 810 applies a prediction algorithm to predict a next connection setup event 820. The prediction component 810 may use machine learning (ML) to predict the next connection setup event 820. In some examples, the prediction component 810 may additionally, or alternatively, classify a next active PDU session based on the next connection setup event 820. For example, based on the next connection setup event 820, the prediction component 810 may classify PDU session K as the next active PDU session. The UE 804 may then perform a selection procedure 830 based on the output of the prediction component 810 to select a frequency channel. For example, the UE 804 may use network slice information to determine which frequency channel to prioritize based on the next active PDU session. For example, and referring to the example of FIG. 7, the UE may determine to select the frequency channel 1 based on the first PDU session 710 being predicted as the next active PDU session.

In the illustrated example of FIG. 8, the prediction component 810 uses a current time 812 and a time sequence 814 of connection setup events for each PDU session to make its prediction of the next connection setup event 820. The current time 812 may correspond to the time at which the prediction component 810 is performing the prediction procedure. For example, and referring to the example of FIG. 7, the current time 812 may correspond to the time TO. The time sequence 814 may correspond to a plurality of connection setup events that occurred over a period. For example, and referring to the example of FIG. 7, the time sequence 814 may correspond to the entries in the log 730.

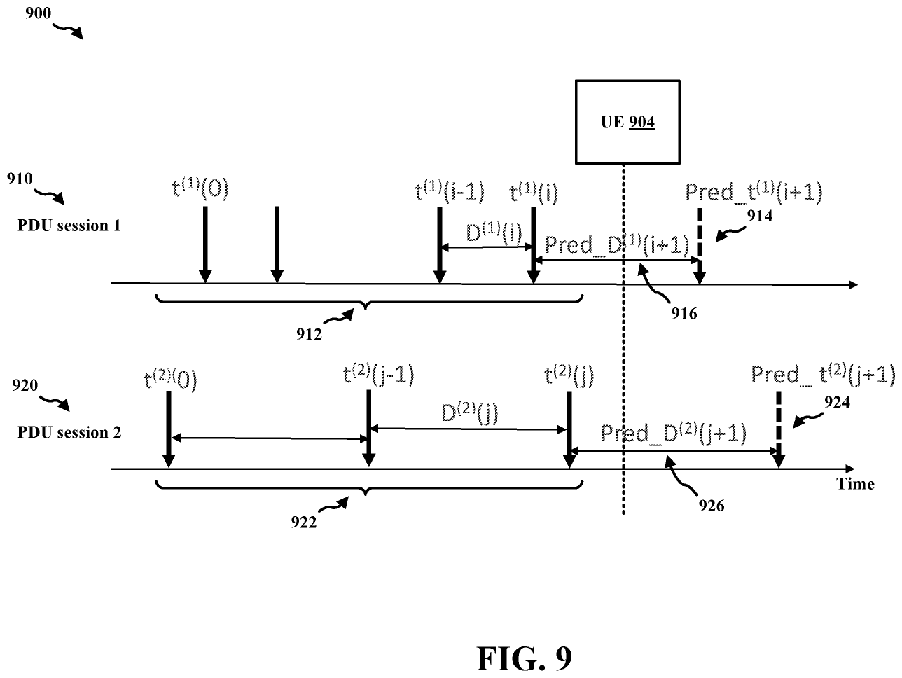

In some aspects, the prediction component 810 may predict the next connection setup event 820 based on inter-connection setup times D. FIG. 9 depicts a timing diagram 900 illustrating predictions of next connection setup events by a UE 904, as presented herein. In the illustrated example of FIG. 9, the timing diagram 900 includes connection setup events associated with a first PDU session 910 and a second PDU session 920. Although the example of FIG. 9 includes two PDU sessions, in other examples, the number of PDU sessions associated with a UE may be any suitable quantity of PDU sessions.

In the illustrated example of FIG. 9, the timing diagram 900 includes past connection setup events 912 associated with the first PDU session 910. The timing diagram 900 also includes past connection setup events 922 associated with the second PDU session 920. The past connection setup events may be logged (e.g., recorded) in a log, such as the log 730 of FIG. 7. For example, and with respect to the first PDU session 910, the past connection setup events 912 include connection setup events at times {t⁽¹⁾(0), . . . , t⁽¹⁾(i−1), and t⁽¹⁾(i)}. The past connection setup events 922 associated with the second PDU session 920 include connection setup events at times {t⁽²⁾(0), t⁽²⁾(j−1), and t⁽²⁾(j)}.

A prediction component of the UE 904, such as the prediction component 810 of FIG. 8, may calculate inter-connection setup times {D⁽¹⁾(0), . . . , D⁽¹⁾(i)} for the first PDU session 910 and may calculate inter-connection setup times {D⁽²⁾(0), . . . , D⁽²⁾(j)} for the second PDU session 920. For example, an i-th inter-connection setup time D⁽¹⁾(i) may be based on the time between the connection setup event at time t⁽¹⁾(i−1) and time t⁽¹⁾(i). Similarly, and with respect to the second PDU session 920, a j-th inter-connection setup time D⁽²⁾(j) may be based on the time between the connection setup event at time t⁽²⁾(j−1) and time t⁽²⁾(j).

The UE 904 may then estimate (e.g., predict) a next connection setup time for each of the PDU sessions based on the most recent connection setup event and the inter-connection setup time. For example, the UE 904 may estimate a first next connection setup time 914 (Pred_t⁽ⁱ⁾(i+1)) for the first PDU session 910 using Equation 1 (below) and may estimate a second next connection setup time 924 (Pred_t⁽²⁾(j+1)) for the second PDU session 920 using Equation 2 (below).

Pred_t⁽¹⁾(i+1)=t⁽¹⁾(i)+Pred_D⁽¹⁾(i+1) Equation 1:

Pred_t⁽²⁾(j+1)=t⁽²⁾(j)+Pred_D⁽²⁾(j+1) Equation 2:

In Equation 1, the first next connection setup time 914 is determined based on the most recent connection setup event associated with the first PDU session 910 (e.g., at time t⁽¹⁾(i)) and based on a predicted inter-connection setup interval 916 (e.g., Pred_D⁽¹⁾(i+1)). Similarly, in Equation 2, the second next connection setup time 924 is determined based on the most recent connection setup event associated with the second PDU session 920 (e.g., at time t⁽²⁾(j)) and based on a predicted inter-connection setup interval 926 (e.g., Pred_D⁽²⁾(j+1)). The predicted inter-connection setup interval 916 may be determined based on the inter-connection setup times {D⁽¹⁾(0), . . . , D⁽¹⁾(i)} for the first PDU session 910. Similarly, the predicted inter-connection setup interval 926 may be determined based on the inter-connection setup times {D⁽²⁾(0), . . . , D⁽²⁾(j)} for the second PDU session 920.

The UE 904 may then classify the next active PDU session based on the first next connection setup time 914 and the second next connection setup time 924. For example, if the first next connection setup time 914 is earlier than the second next connection setup time 924 in the time domain, the UE 904 may select the first PDU session 910 as the next active PDU session. Otherwise, if the second next connection setup time 924 is earlier than the first next connection setup time 914 in the time domain, the UE 904 may select the second PDU session 920 as the next active PDU session.

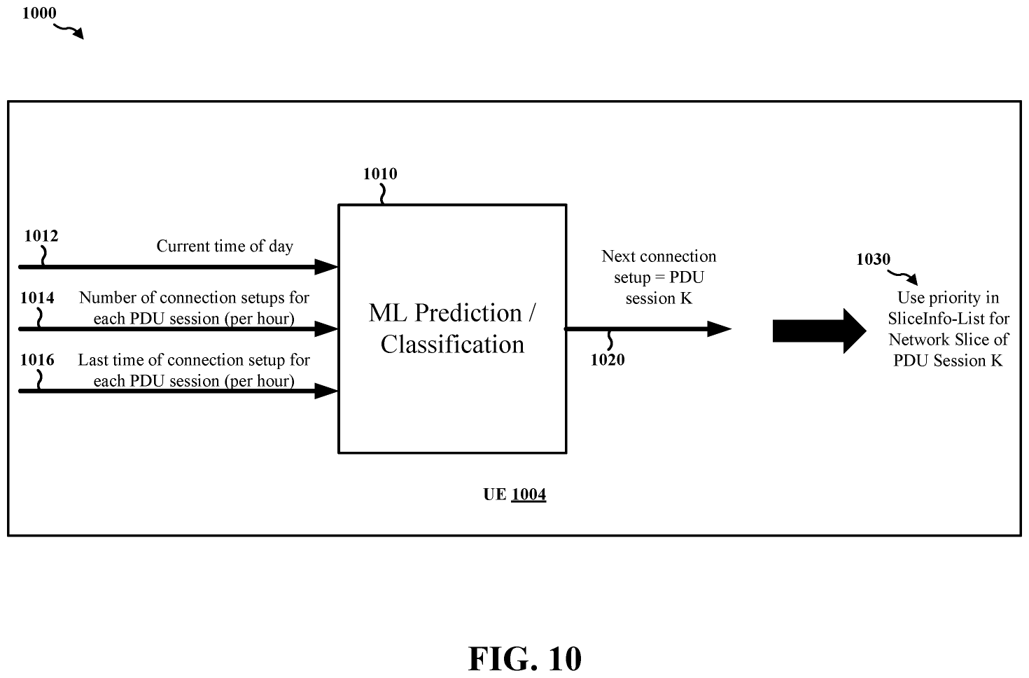

In the illustrated examples of FIG. 8 and FIG. 9, the UE uses a time sequence of connection setup events to predict the next active PDU session. However, in some examples, the UE may reduce the amount of data used to predict the next active PDU session. For example, FIG. 10 illustrates an example of a prediction procedure 1000 applied by a UE 1004 based on a smaller set of input data, as presented herein. In the example of FIG. 10, a prediction component 1010 applies a prediction algorithm to predict a next connection setup event 1020. The prediction component 1010 may use machine learning to predict the next connection setup event 1020. In some examples, the prediction component 1010 may additionally, or alternatively, classify a next active PDU session based on the next connection setup event 1020. For example, based on the next connection setup event 1020, the prediction component 1010 may classify PDU session K as the next active PDU session. The UE 1004 may then perform a selection procedure 1030 based on the output of the prediction component 1010 to select a frequency channel. For example, the UE 1004 may use network slice information to determine which frequency channel to prioritize based on the next active PDU session. For example, and referring to the example of FIG. 7, the UE may determine to select the frequency channel 1 based on the first PDU session 710 being predicted as the next active PDU session.

In the illustrated example of FIG. 10, the prediction component 810 uses a current time 1012, a connection setups quantity 1014, and a last connection setup time 1016 to make its prediction of the next connection setup event 1020. The current time 1012 may correspond to the time at which the prediction component 1010 is performing the prediction procedure. For example, and referring to the example of FIG. 7, the current time 1012 may correspond to the time TO. The prediction component 1010 may determine an index of a current time interval based on the current time 1012. For example, the prediction component 1010 may convert the current time 1012 into 24 intervals and where each interval represents an hour of the day (e.g., interval=0, . . . , 23).

The connection setups quantity 1014 may correspond to a quantity of connection setup events that occurred over the index of the current time interval. For example, and referring to the example of FIG. 7, the connection setups quantity 1014 may correspond to the entries in the log 730 that occurred over the index of the current time interval. The last connection setup time 1016 may correspond to the last connection setup time for the respective PDU session that occurred over the index of the current time interval.

As an example, and referring to the example of FIG. 7, the current time 1012 may correspond to 6:59. In such an example, the prediction component 1010 may determine the index of the current time interval to be six. The prediction component 1010 may also determine that the connection events quantity for the first PDU session 710 is three and the connection events quantity for the second PDU session 720 is two. The prediction component 1010 may also determine that the last connection setup time 1016 for the first PDU session 710 is 6:43 and the last connection setup time 1016 for the second PDU session 720 is 6:58.

Similar to the example of FIG. 9, the prediction component 1010 may then predict the next connection setup event 1020 based on inter-connection setup times D.

Although the example of FIG. 10 describes an interval corresponding to one hour, in other examples, the interval may be any suitable quantity of time, such as X minutes.

In some aspects, the UE may further reduce the amount of data used to predict the next active PDU session based on heuristics. For example, the UE may use input data for a current hour and calculate an average inter-connection setup time for each established PDU session. In some examples, the UE may use Equation 3 and Equation 4 to determine the average inter-connection setup time for a first PDU session and a second PDU session, respectively.

$${Pred\_D}^{( 1 )} = \frac{L * 3600}{number\_connection \_setups \_current \_hour \_PDU \_session \_ 1} \qquad Equation 3$$

$${Pred\_D}^{( 2 )} = \frac{L * 3600}{number\_connection \_setups \_current \_hour \_PDU \_session \_ 2} \qquad Equation 4$$

In Equation 3 and Equation 4, the numerator is based on a period of L days and the time interval being one hour or 3600 seconds. The denominator represents the number of connection setups that occurred over the current hour for each respective PDU session. As an example, over a same hour period (e.g., 6:00 to 6:59) of two days (e.g., L=2), there may be 4 connection setup events for the first PDU session and 6 connection setup events for the second PDU session. In such an example, the average inter-connection setup time for the first PDU session is 2 connection events per hour (or one every 30 minutes or 1800 seconds) and the average inter-connection setup time for the second PDU session is 3 connection events per hour (or one every 20 minutes or 1200 seconds).

The UE may then predict the next connection setup time for each PDU session based on the last respective connection setup time. For example, the UE may use Equation 5 and Equation 6 to estimate the next respective connection setup times and the next active PDU session.

Pred_t⁽¹⁾=last_time_connection_setup+Pred_D⁽¹⁾ Equation 5:

Pred_t⁽²⁾=last_time_connection_setup+Pred_D⁽²⁾ Equation 6:

In Equation 5 and Equation 6, the term “last_time_connection_setup” corresponds to the most recent connection setup time associated with the respective PDU session. As an example, the current time may be 6:30. In such an example, and referring to the connection setup events of the log 730 of FIG. 7, the UE may estimate the next connection setup time for the first PDU session as 6:48 (e.g., 6:18+30 minutes). The UE may estimate the next connection setup time for the second PDU session as 6:46 (e.g., 6:26+20 minutes). The UE may then select the next active PDU session based on the earlier of the two next connection setup times. For example, and referring to the above example, the UE may select the second PDU session as the next active PDU session as 6:46 occurs before 6:48 in the time domain.

In some examples, the different in estimated next connection setup times may be within a small time window. In some such examples, it may be beneficial to select the next active PDU session based on a later occurring estimated next connection setup time. For example, if the later occurring next connection setup time is associated with a higher priority PDU session, then the UE may be configured to select the higher priority PDU session as the next active PDU session and, thus, select the frequency channel based on the higher priority PDU session.

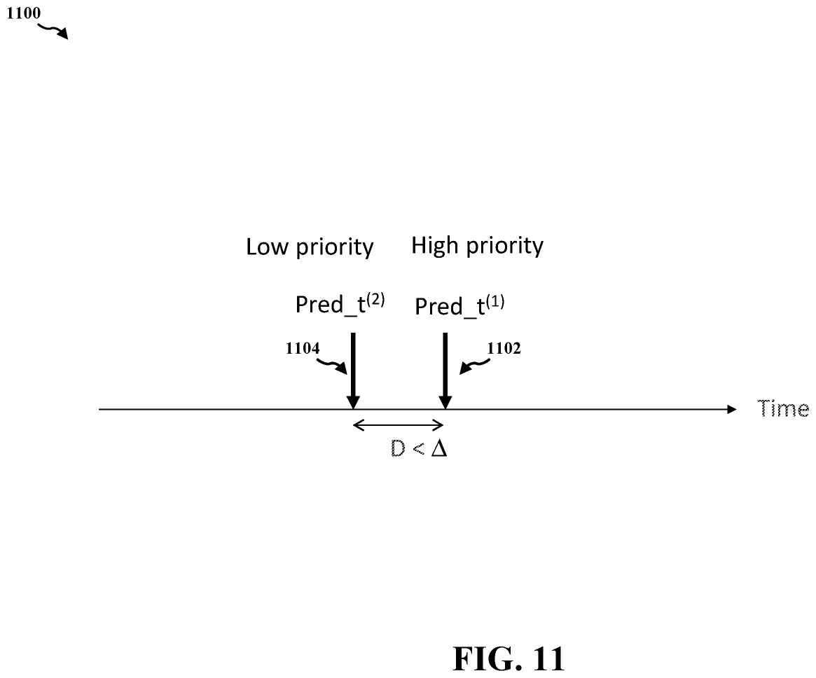

FIG. 11 depicts an example timing diagram 1100 in which the next active PDU session is selected based on priority and a delta threshold, as presented herein. In the illustrated example of FIG. 11, a first next connection setup time 1102 (Pred_t⁽¹⁾) is associated with a first PDU session and a second next connection setup time 1104 (Pred_t⁽²⁾) is associated with a second PDU session. As shown in FIG. 11, the second next connection setup time 1104 occurs earlier than the first next connection setup time 1102 in the time domain. However, the UE may determine that the network slice associated with the first PDU session has a higher priority than the network slice associated with the second PDU session. In the example of FIG. 11, the UE may select the first PDU session as the next active PDU session when a difference between the first next connection setup time 1102 and the second next connection setup time 1104 satisfies a delta threshold and the priority of the network slice associated with the first PDU session is higher than the priority of the network slice associated with the second PDU session.

For example, the UE may use Equation 7 (below) to determine whether the difference between the next connection setup times satisfies the delta threshold.

0<(Pred_t⁽¹⁾−Pred_t⁽²⁾=D)<Δ Equation 7:

In Equation 7, the term “D” represents the difference between the first next connection setup time 1102 and the second next connection setup time 1104. Thus, if the difference D is greater than 0, but less than the delta threshold (Δ), then the UE may select the PDU session associated with the first next connection setup time 1102 if the priority of the network slice associated with the first PDU session is higher than the priority of the network slice associated with the second PDU session. For example, the first PDU session may use a network slice associated with URLLC data and the second PDU session may use a network slice associated with eMBB data. In such examples, the UE may select the first PDU session as the next active PDU session if the URLLC slice has a higher priority than the eMBB slice.

Although the example of FIG. 11 includes two next connection setup events, other examples may include any suitable quantity of next connection setup events that occur within a delta threshold. In some such examples, the UE may select the next active PDU session based on the network slice associated with the highest priority. In some examples in which two or more of the network slices are associated with the same priority, the UE may select the next active PDU session based on the earliest occurring next connection setup time. For example, in the example of FIG. 11, if the network slices associated with the first PDU session and the second PDU session each have the same priority, then the UE may select the second PDU session as the next active PDU session based on the second next connection setup time 1104 occurring earlier than the first next connection setup time 1102.

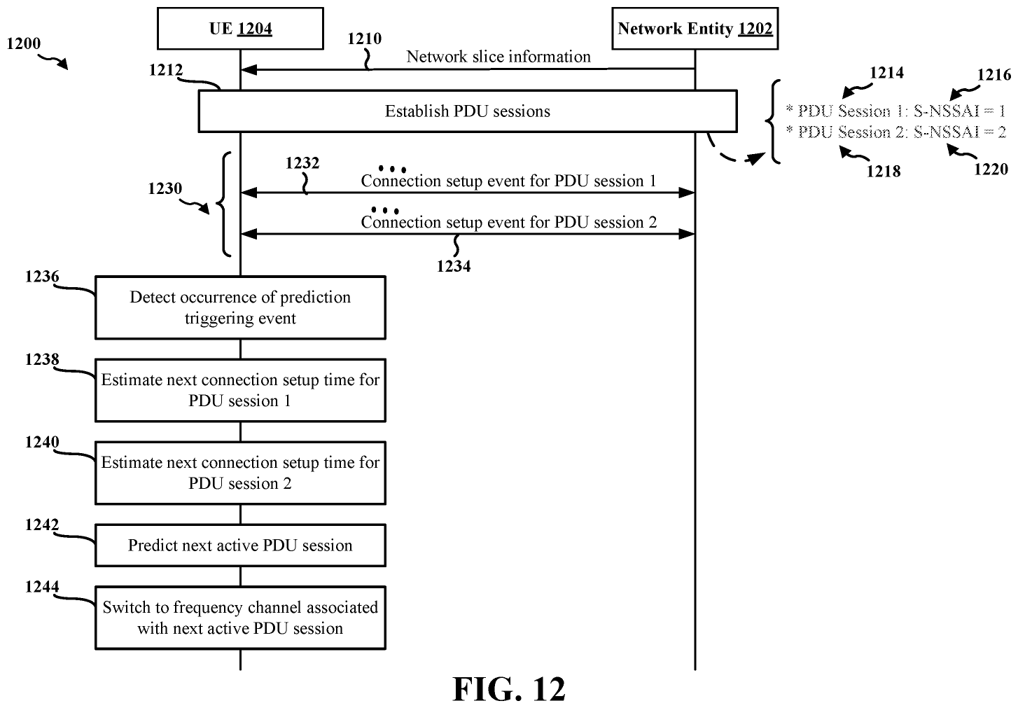

FIG. 12 illustrates an example communication flow 1200 between a network entity 1202 and a UE 1204, as presented herein. One or more aspects described for the network entity 1202 may be performed by a component of a base station or a network entity, such as a CU, a DU, and/or an RU. In the illustrated example, the communication flow 1200 facilitates the UE 1204 selecting a frequency channel to camp on based on a predicted next active PDU session. Aspects of the network entity 1202 may be implemented by the base station 102 of FIG. 1 and/or the base station 310 of FIG. 3. Aspects of the UE 1204 may be implemented by the UE 104 of FIG. 1 and/or the UE 350 of FIG. 3. Although not shown in the illustrated example of FIG. 12, it may be appreciated that in additional or alternative examples, the network entity 1202 and/or the UE 1204 may be in communication with one or more other base stations or UEs.

In the example of FIG. 12, the network entity 1202 may output (e.g., transmit) network slice information 1210 that is received by the UE 1204. The network entity 1202 may output the network slice information 1210 via a SIB, such as SIBx. The network slice information 1210 may identify one or more network slice instances that are identifiable via respective S-NSSAIs. The network slice information 1210 may also indicate one or more frequency channel associated with each network slice instance and a priority associated with each of the one or more respective frequency channels. Aspects of the network slice information 1210 may be implemented by the network slice information 510 of FIG. 5.

The UE 1204 may establish PDU sessions via an establishing procedure 1212. In the example of FIG. 12, the UE 1204 may establish a first PDU session 1214 that is associated with a first network slice instance 1216. The UE 1204 may also establish a second PDU session 1218 that is associated with a second network slice instance 1220.

As shown in FIG. 12, the UE 1204 may perform a sequence of connection setup events associated with the respective PDU sessions over a period 1230. For example, the UE 1204 may perform a first connection setup event 1232 associated with the first PDU session 1214, and may perform a second connection setup event 1234 associated with the second PDU session 1218.

In some examples, the UE 1204 may detect the occurrence of a prediction triggering event via a triggering procedure 1236. Examples of an occurrence of a prediction triggering event may include performing a connection release, performing a cell change, or may be based on a period (e.g., may be performed periodically).

The UE 1204 may perform an estimation procedure 1238 to estimate a first next connection setup time for the first PDU session 1214. The UE 1204 may also perform an estimation procedure 1240 to estimate a second next connection setup time for the second PDU session 1218. In some examples, the UE 1204 may estimate the next connection setup times for the respective PDU sessions based on inter-connection setup events and a time sequence of connection setup events, as described in connection with the examples of FIG. 8 and FIG. 9. In some examples, the UE 1204 may estimate the next connection setup times for the respective PDU sessions based on inter-connection setup events and past connections setup events occurring over an interval, as described in connection with the examples of FIG. 10 and FIG. 9. In some examples, the UE 1204 may estimate the next connection setup times for the respective PDU sessions based on average inter-connection setup events, as described in connection with Equation 5 and Equation 6 (above).

The UE 1204 may then predict a next active PDU session via a prediction procedure 1242. For example, the UE 1204 may select the next active PDU session based on the earlier occurring of the first next connection setup time and the second next connection setup time. In some examples, the UE 1204 may select the next active PDU session based on the later occurring next connection setup time when the difference in time between the next connection setup times satisfies a delta threshold (e.g., is less than or equal to a small time window) and the network slice instance associated with the respective PDU session has a higher priority than the other network slice instance, as described in connection with the example of FIG. 11.

In some examples, the UE 1204 may perform a switching procedure 1244 to switch to the frequency channel associated with the next active PDU session while operating in an inactive mode or an idle mode. For example, the UE 1204 may perform the switching procedure 1244 when a current frequency channel is different than the frequency channel associated with the next active PDU session.

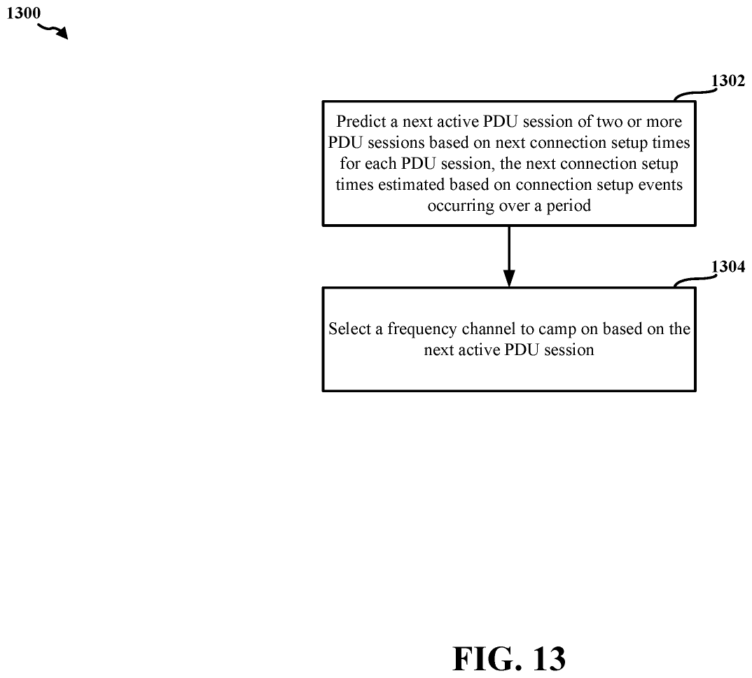

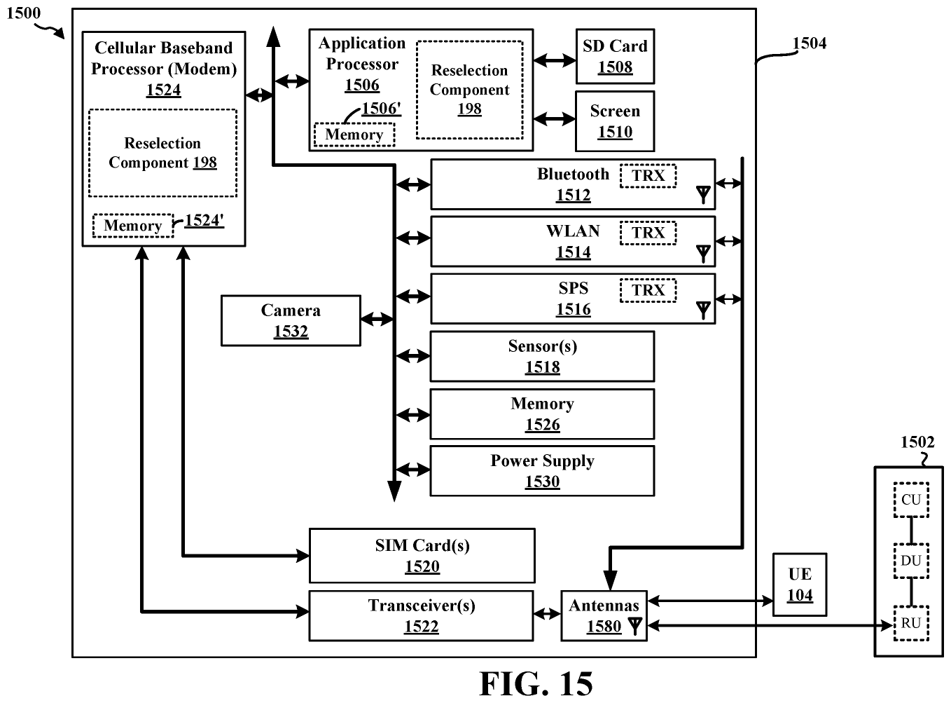

FIG. 13 is a flowchart 1300 of a method of wireless communication. The method may be performed by a UE (e.g., the UE 104, and/or an apparatus 1504 of FIG. 15). The method may facilitate predicting a next active PDU session and to switch to a corresponding frequency channel to camp on, which may facilitate improving communication performance, for example, by reducing delays and/or service disruptions associated with changing to the frequency channel when a connection setup is requested.

At 1302, the UE predicts a next active PDU session of two or more PDU sessions based on next connection setup times for each PDU session, as described in connection with at least the prediction procedure 1242 of FIG. 12. The next connection setup times may be estimated based on connection setup events occurring over a period, as described in connection with at least the period 1230 of FIG. 12. The predicting of the next active PDU session, at 1302, may be performed by the reselection component 198 of the apparatus 1504 of FIG. 15.

In some examples, the UE may predict the next active PDU session, at 1420, at least one of after performing a connection release, after performing a cell change, or periodically.

At 1304, the UE selects a frequency channel to camp on based on the next active PDU session, as described in connection with at least the selection procedure 744 of FIG. 7. The selecting of the frequency channel, at 1304, may be performed by a cellular RF transceiver 1522/the reselection component 198 of the apparatus 1504 of FIG. 15.

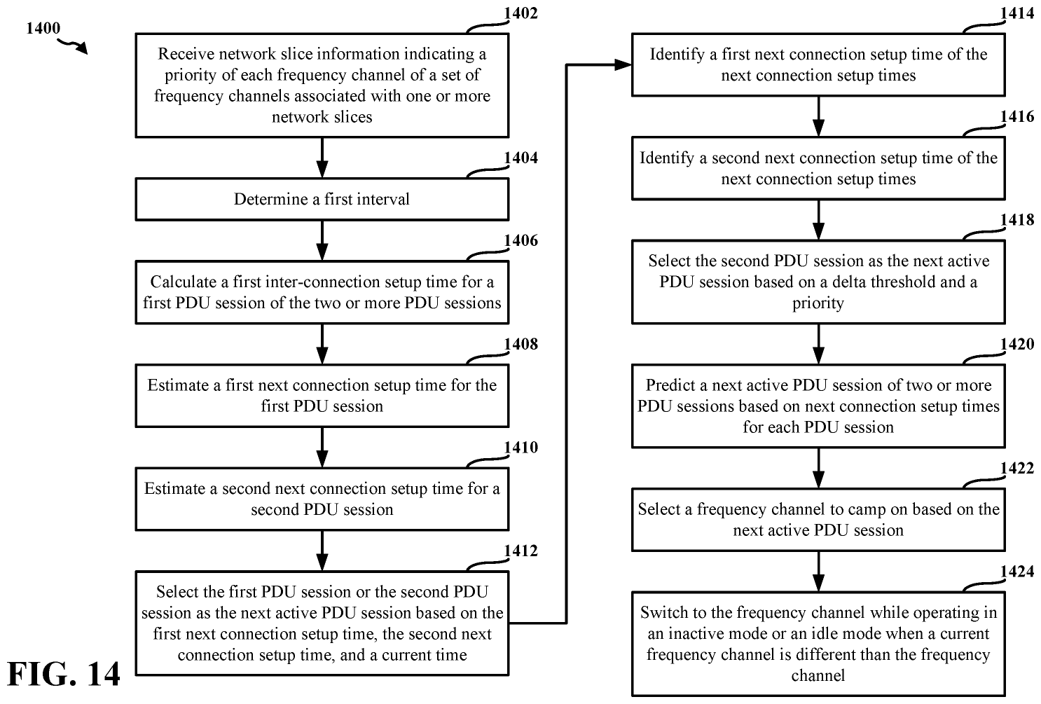

FIG. 14 is a flowchart 1400 of a method of wireless communication. The method may be performed by a UE (e.g., the UE 104, and/or an apparatus 1504 of FIG. 15). The method may facilitate predicting a next active PDU session and to switch to a corresponding frequency channel to camp on, which may facilitate improving communication performance, for example, by reducing delays and/or service disruptions associated with changing to the frequency channel when a connection setup is requested.

At 1420, the UE predicts a next active PDU session of two or more PDU sessions based on next connection setup times for each PDU session, as described in connection with at least the prediction procedure 1242 of FIG. 12. The next connection setup times may be estimated based on connection setup events occurring over a period, as described in connection with at least the period 1230 of FIG. 12. The predicting of the next active PDU session, at 1420, may be performed by the reselection component 198 of the apparatus 1504 of FIG. 15.

In some examples, the UE may predict the next active PDU session, at 1420, at least one of after performing a connection release, after performing a cell change, or periodically.

At 1422, the UE selects a frequency channel to camp on based on the next active PDU session, as described in connection with at least the selection procedure 744 of FIG. 7. The selecting of the frequency channel, at 1422, may be performed by a cellular RF transceiver 1522/the reselection component 198 of the apparatus 1504 of FIG. 15.

At 1424, the UE may switch to the frequency channel while operating in an inactive mode or an idle mode when a current frequency channel is different than the frequency channel, as described in connection with at least the switching procedure 1244 of FIG. 12. The switching to the frequency channel, at 1424, may be performed by the cellular RF transceiver 1522/the reselection component 198 of the apparatus 1504 of FIG. 15.

In some aspects, the UE may receive, at 1402, network slice information indicating a priority of each frequency channel of a set of frequency channels associated with one or more network slices, as described in connection with at least the network slice information 1210 of FIG. 12. In some examples, each PDU session of the two or more PDU sessions may be associated with a respective network slice and a respective frequency channel based on the network slice information. The receiving of the network slice information, at 1402, may be performed by the cellular RF transceiver 1522/the reselection component 198 of the apparatus 1504 of FIG. 15.

In some aspects, the UE may prioritize a PDU session as the next active PDU session. For example, at 1414, the UE may identify a first next connection setup time of the next connection setup times, the first next connection setup time associated with a first PDU session of the two or more PDU sessions, as described in connection with at least the second next connection setup time 1104 of FIG. 11. The identifying of the first next connection setup time, at 1414, may be performed by the cellular RF transceiver 1522/the reselection component 198 of the apparatus 1504 of FIG. 15.

At 1416, the UE may identify a second next connection setup time of the next connection setup times, the second next connection setup time associated with a second PDU session of the two or more PDU sessions, the first next connection setup time occurring earlier than the second next connection setup time in a time domain, as described in connection with at least first next connection setup time 1102 of FIG. 11. The identifying of the second next connection setup time, at 1416, may be performed by the cellular RF transceiver 1522/the reselection component 198 of the apparatus 1504 of FIG. 15.

At 1418, the UE may select the second PDU session as the next active PDU session when a difference between the first next connection setup time and the second next connection setup time satisfies a delta threshold, and a first priority of a first network slice associated with the first PDU session is lower than a second priority of a second network slice associated with the second PDU session, as described in connection with at least the example of FIG. 11. The selecting of the second PDU session as the next active PDU session, at 1418, may be performed by the cellular RF transceiver 1522/the reselection component 198 of the apparatus 1504 of FIG. 15.

In some aspects, the UE may predict the next active PDU session, at 1420, based on a time sequence of connection setup events. For example, at 1406, the UE may calculate a first inter-connection setup time for a first PDU session of the two or more PDU sessions based on a subset of the connection setup events, the subset of the connection setup events including a time sequence of each connection setup event associated with the first PDU session over the period, as described in connection with at least the predicted inter-connection setup interval 916 of FIG. 9. The calculating of the first inter-connection setup time, at 1406, may be performed by the cellular RF transceiver 1522/the reselection component 198 of the apparatus 1504 of FIG. 15.

At 1408, the UE may estimate a first next connection setup time for the first PDU session based on the first inter-connection setup time for the first PDU session and a last first PDU session connection setup time, as described in connection with at least the estimation procedure 1238 of FIG. 12 and/or the Equation 1 (above). The estimating of the first next connection setup time, at 1408, may be performed by the cellular RF transceiver 1522/the reselection component 198 of the apparatus 1504 of FIG. 15.

At 1410, the UE may estimate a second next connection setup time for a second PDU session based on a second inter-connection setup time for the second PDU session and a last second PDU session connection setup time, as described in connection with at least the estimation procedure 1240 of FIG. 12 and/or the Equation 2 (above). The estimating of the second next connection setup time, at 1410, may be performed by the cellular RF transceiver 1522/the reselection component 198 of the apparatus 1504 of FIG. 15.

In some examples, the first inter-connection setup time and the second inter-connection setup time may be calculated using a predictive algorithm.

At 1412, the UE may select the first PDU session or the second PDU session as the next active PDU session based on the first next connection setup time, the second next connection setup time, and a current time, as described in connection with at least the prediction procedure 1242 of FIG. 12. The selecting, at 1412, may be performed by the cellular RF transceiver 1522/the reselection component 198 of the apparatus 1504 of FIG. 15.

In some aspects, the UE may predict the next active PDU session, at 1420, based on past connections setup events occurring over an interval. For example, at 1404, the UE may determine a first interval, as described in connection with at least the current time 1012 of FIG. 10. The determining of the first interval, at 1404, may be performed by the cellular RF transceiver 1522/the reselection component 198 of the apparatus 1504 of FIG. 15.

At 1406, the UE may calculate a first inter-connection setup time for a first PDU session of the two or more PDU sessions based on a first quantity of the connection setup events associated with the first PDU session and occurring during the first interval, as described in connection with at least the examples of FIG. 9. The calculating of the first inter-connection setup time, at 1406, may be performed by the cellular RF transceiver 1522/the reselection component 198 of the apparatus 1504 of FIG. 15.

At 1408, the UE may estimate a first next connection setup time for the first PDU session based on the first inter-connection setup time and a last first PDU session connection setup time, as described in connection with at least the estimation procedure 1238 of FIG. 12. The estimating of the first next connection setup time, at 1408, may be performed by the cellular RF transceiver 1522/the reselection component 198 of the apparatus 1504 of FIG. 15.

At 1410, the UE may estimate a second next connection setup time for a second PDU session based on a second inter-connection setup time for the second PDU session and a last second PDU session connection setup time, as described in connection with at least the estimation procedure 1240 of FIG. 12. The estimating of the second next connection setup time, at 1410, may be performed by the cellular RF transceiver 1522/the reselection component 198 of the apparatus 1504 of FIG. 15.

In some examples, the first inter-connection setup time and the second inter-connection setup time may be calculated using a predictive algorithm.

At 1412, the UE may select the first PDU session or the second PDU session as the next active PDU session based on the first next connection setup time, the second next connection setup time, and a current time of day, as described in connection with at least the prediction procedure 1242 of FIG. 12. The selecting, at 1412, may be performed by the cellular RF transceiver 1522/the reselection component 198 of the apparatus 1504 of FIG. 15.

In some aspects, the UE may predict the next active PDU session, at 1420, based on heuristics. For example, at 1406, the UE may calculate a first average inter-connection time for a first PDU session of the two or more PDU sessions based on a first quantity of the connection setup events associated with the first PDU session over the period, as described in connection with at least Equation 3 (above). The calculating of the first average inter-connection time, at 1406, may be performed by the cellular RF transceiver 1522/the reselection component 198 of the apparatus 1504 of FIG. 15.

At 1408, the UE may estimate a first next connection setup time for the first PDU session based on the first average inter-connection time and a last first PDU session connection setup time, as described in connection with at least the estimation procedure 1238 of FIG. 12. The estimating of the first next connection setup time, at 1408, may be performed by the cellular RF transceiver 1522/the reselection component 198 of the apparatus 1504 of FIG. 15.

At 1410, the UE may estimate a second next connection setup time for a second PDU session based on a second average inter-connection time for the second PDU session and a last second PDU session connection setup time, as described in connection with at least the estimation procedure 1240 of FIG. 12. The estimating of the second next connection setup time, at 1410, may be performed by the cellular RF transceiver 1522/the reselection component 198 of the apparatus 1504 of FIG. 15.

At 1412, the UE may select the first PDU session or the second PDU session as the next active PDU session based on the first next connection setup time, the second next connection setup time, and a current time of day, as described in connection with at least the prediction procedure 1242 of FIG. 12. The selecting, at 1412, may be performed by the cellular RF transceiver 1522/the reselection component 198 of the apparatus 1504 of FIG. 15.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers (e.g., a cellular RF transceiver 1522). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize one or more antennas 1580 for communication. The cellular baseband processor 1524 communicates through transceiver(s) (e.g., the cellular RF transceiver 1522) via one or more antennas 1580 with the UE 104 and/or with an RU associated with a network entity 1502. The cellular baseband processor 1524 and the application processor 1506 may each include a computer-readable medium/memory, such as the on-chip memory 1524′, and the on-chip memory 1506′, respectively. The additional memory modules 1526 may also be considered a computer-readable medium/memory. Each computer-readable medium/memory (e.g., the on-chip memory 1524′, the on-chip memory 1506′, and/or the additional memory modules 1526) may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see the UE 350 of FIG. 3) and include the additional modules of the apparatus 1504.

As discussed supra, the reselection component 198 is configured to predict a next active PDU session of two or more PDU sessions based on next connection setup times for each PDU session, the next connection setup times estimated based on connection setup events occurring over a period. The reselection component 198 is also configured to select a frequency channel to camp on based on the next active PDU session.

The reselection component 198 may be within the cellular baseband processor 1524, the application processor 1506, or both the cellular baseband processor 1524 and the application processor 1506. The reselection component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1504 may include a variety of components configured for various functions. For example, the reselection component 198 may include one or more hardware components that perform each of the blocks of the algorithm in the flowcharts of FIG. 13 and/or FIG. 14.

In one configuration, the apparatus 1504, and in particular the cellular baseband processor 1524 and/or the application processor 1506, includes means for predicting a next active protocol data unit (PDU) session of two or more PDU sessions based on next connection setup times for each PDU session, the next connection setup times estimated based on connection setup events occurring over a period. The example apparatus 1504 also includes means for selecting a frequency channel to camp on based on the next active PDU session.

In another configuration, the example apparatus 1504 also includes means for switching to the frequency channel while operating in an inactive mode or an idle mode when a current frequency channel is different than the frequency channel.

In another configuration, the example apparatus 1504 also includes means for receiving network slice information indicating a priority of each frequency channel of a set of frequency channels associated with one or more network slices, and where each PDU session of the two or more PDU sessions is associated with a respective network slice and a respective frequency channel based on the network slice information.

In another configuration, the example apparatus 1504 also includes means for identifying a first next connection setup time of the next connection setup times, the first next connection setup time associated with a first PDU session of the two or more PDU sessions. The example apparatus 1504 also includes means for identifying a second next connection setup time of the next connection setup times, the second next connection setup time associated with a second PDU session of the two or more PDU sessions, the first next connection setup time occurring earlier than the second next connection setup time in a time domain. The example apparatus 1504 also includes means for selecting the second PDU session as the next active PDU session when a difference between the first next connection setup time and the second next connection setup time satisfies a delta threshold, and a first priority of a first network slice associated with the first PDU session is lower than a second priority of a second network slice associated with the second PDU session.

In another configuration, the example apparatus 1504 also includes means for calculating a first inter-connection setup time for a first PDU session of the two or more PDU sessions based on a subset of the connection setup events, the subset of the connection setup events including a time sequence of each connection setup event associated with the first PDU session over the period. The example apparatus 1504 also includes means for estimating a first next connection setup time for the first PDU session based on the first inter-connection setup time for the first PDU session and a last first PDU session connection setup time. The example apparatus 1504 also includes means for estimating a second next connection setup time for a second PDU session based on a second inter-connection setup time for the second PDU session and a last second PDU session connection setup time. The example apparatus 1504 also includes means for selecting the first PDU session or the second PDU session as the next active PDU session based on the first next connection setup time, the second next connection setup time, and a current time.

In another configuration, the example apparatus 1504 also includes means for determining a first interval. The example apparatus 1504 also includes means for calculating a first inter-connection setup time for a first PDU session of the two or more PDU sessions based on a first quantity of the connection setup events associated with the first PDU session and occurring during the first interval. The example apparatus 1504 also includes means for estimating a first next connection setup time for the first PDU session based on the first inter-connection setup time and a last first PDU session connection setup time. The example apparatus 1504 also includes means for estimating a second next connection setup time for a second PDU session based on a second inter-connection setup time for the second PDU session and a last second PDU session connection setup time. The example apparatus 1504 also includes means for selecting the first PDU session or the second PDU session as the next active PDU session based on the first next connection setup time, the second next connection setup time, and a current time of day.

In another configuration, the example apparatus 1504 also includes means for calculating a first average inter-connection time for a first PDU session of the two or more PDU sessions based on a first quantity of the connection setup events associated with the first PDU session over the period. The example apparatus 1504 also includes means for estimating a first next connection setup time for the first PDU session based on the first average inter-connection time and a last first PDU session connection setup time. The example apparatus 1504 also includes means for estimating a second next connection setup time for a second PDU session based on a second average inter-connection time for the second PDU session and a last second PDU session connection setup time. The example apparatus 1504 also includes means for selecting the first PDU session or the second PDU session as the next active PDU session based on the first next connection setup time, the second next connection setup time, and a current time of day.

The means may be the reselection component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

The aspects presented herein may enable a UE to predict a next active PDU session and to switch to a corresponding frequency channel to camp on, which may facilitate improving communication performance, for example, by reducing delays and/or service disruptions associated with changing to the frequency channel when a connection setup is requested.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, including predicting a next active protocol data unit (PDU) session of two or more PDU sessions based on next connection setup times for each PDU session, the next connection setup times estimated based on connection setup events occurring over a period; and selecting a frequency channel to camp on based on the next active PDU session.
Aspect 2 is the method of aspect 1, further including: switching to the frequency channel while operating in an inactive mode or an idle mode when a current frequency channel is different than the frequency channel.
Aspect 3 is the method of any of aspects 1 and 2, further including: receiving network slice information indicating a priority of each frequency channel of a set of frequency channels associated with one or more network slices, and where each PDU session of the two or more PDU sessions is associated with a respective network slice and a respective frequency channel based on the network slice information.
Aspect 4 is the method of any of aspects 1 to 3, further including: identifying a first next connection setup time of the next connection setup times, the first next connection setup time associated with a first PDU session of the two or more PDU sessions; identifying a second next connection setup time of the next connection setup times, the second next connection setup time associated with a second PDU session of the two or more PDU sessions, the first next connection setup time occurring earlier than the second next connection setup time in a time domain; and selecting the second PDU session as the next active PDU session when a difference between the first next connection setup time and the second next connection setup time satisfies a delta threshold, and a first priority of a first network slice associated with the first PDU session is lower than a second priority of a second network slice associated with the second PDU session.
Aspect 5 is the method of any of aspects 1 to 4, further including that the UE predicts the next active PDU session at least one of after performing a connection release, after performing a cell change, or periodically.
Aspect 6 is the method of any of aspects 1 to 5, further including: calculating a first inter-connection setup time for a first PDU session of the two or more PDU sessions based on a subset of the connection setup events, the subset of the connection setup events including a time sequence of each connection setup event associated with the first PDU session over the period; estimating a first next connection setup time for the first PDU session based on the first inter-connection setup time for the first PDU session and a last first PDU session connection setup time; estimating a second next connection setup time for a second PDU session based on a second inter-connection setup time for the second PDU session and a last second PDU session connection setup time; and selecting the first PDU session or the second PDU session as the next active PDU session based on the first next connection setup time, the second next connection setup time, and a current time.
Aspect 7 is the method of aspect 6, further including that the first inter-connection setup time and the second inter-connection setup time are calculated using a predictive algorithm.
Aspect 8 is the method of any of aspects 1 to 5, further including: determining a first interval; calculating a first inter-connection setup time for a first PDU session of the two or more PDU sessions based on a first quantity of the connection setup events associated with the first PDU session and occurring during the first interval; estimating a first next connection setup time for the first PDU session based on the first inter-connection setup time and a last first PDU session connection setup time; estimating a second next connection setup time for a second PDU session based on a second inter-connection setup time for the second PDU session and a last second PDU session connection setup time; and selecting the first PDU session or the second PDU session as the next active PDU session based on the first next connection setup time, the second next connection setup time, and a current time of day.
Aspect 9 is the method of aspect 8, further including that the first inter-connection setup time and the second inter-connection setup time are calculated using a predictive algorithm.
Aspect 10 is the method of any of aspects 1 to 9, further including: calculating a first average inter-connection time for a first PDU session of the two or more PDU sessions based on a first quantity of the connection setup events associated with the first PDU session over the period; estimating a first next connection setup time for the first PDU session based on the first average inter-connection time and a last first PDU session connection setup time; estimating a second next connection setup time for a second PDU session based on a second average inter-connection time for the second PDU session and a last second PDU session connection setup time; and selecting the first PDU session or the second PDU session as the next active PDU session based on the first next connection setup time, the second next connection setup time, and a current time of day.
Aspect 11 is an apparatus for wireless communication at a UE including at least one processor coupled to a memory and configured to implement any of aspects 1 to 10.
In aspect 12, the apparatus of aspect 11 further includes at least one antenna coupled to the at least one processor.
In aspect 13, the apparatus of aspect 11 or 12 further includes a transceiver coupled to the at least one processor.
Aspect 14 is an apparatus for wireless communication including means for implementing any of aspects 1 to 10.
In aspect 15, the apparatus of aspect 14 further includes at least one antenna coupled to the means to perform the method of any of aspects 1 to 10.
In aspect 16, the apparatus of aspect 14 or 15 further includes a transceiver coupled to the means to perform the method of any of aspects 1 to 10.
Aspect 17 is a non-transitory computer-readable storage medium storing computer executable code, where the code, when executed, causes a processor to implement any of aspects 1 to 10.

What is claimed is:

1. An apparatus for wireless communication at a user equipment (UE), comprising:
a memory; and
at least one processor coupled to the memory and, based at least in part on information stored in the memory, the at least one processor is configured to:
predict a next active protocol data unit (PDU) session of two or more PDU sessions based on next connection setup times for each PDU session, the next connection setup times estimated based on connection setup events occurring over a period; and
select a frequency channel to camp on based on the next active PDU session.

2. The apparatus of claim 1, wherein the at least one processor is further configured to:
switch to the frequency channel while operating in an inactive mode or an idle mode when a current frequency channel is different than the frequency channel.

3. The apparatus of claim 1, wherein the at least one processor is further configured to:
receive network slice information indicating a priority of each frequency channel of a set of frequency channels associated with one or more network slices, and wherein each PDU session of the two or more PDU sessions is associated with a respective network slice and a respective frequency channel based on the network slice information.

4. The apparatus of claim 1, wherein the at least one processor is further configured to:
identify a first next connection setup time of the next connection setup times, the first next connection setup time associated with a first PDU session of the two or more PDU sessions;
identify a second next connection setup time of the next connection setup times, the second next connection setup time associated with a second PDU session of the two or more PDU sessions, the first next connection setup time occurring earlier than the second next connection setup time in a time domain; and
select the second PDU session as the next active PDU session when a difference between the first next connection setup time and the second next connection setup time satisfies a delta threshold, and a first priority of a first network slice associated with the first PDU session is lower than a second priority of a second network slice associated with the second PDU session.

5. The apparatus of claim 1, wherein the UE predicts the next active PDU session at least one of after performing a connection release, after performing a cell change, or periodically.

6. The apparatus of claim 1, wherein the at least one processor is further configured to:
calculate a first inter-connection setup time for a first PDU session of the two or more PDU sessions based on a subset of the connection setup events, the subset of the connection setup events including a time sequence of each connection setup event associated with the first PDU session over the period;
estimate a first next connection setup time for the first PDU session based on the first inter-connection setup time for the first PDU session and a last first PDU session connection setup time;
estimate a second next connection setup time for a second PDU session based on a second inter-connection setup time for the second PDU session and a last second PDU session connection setup time; and
select the first PDU session or the second PDU session as the next active PDU session based on the first next connection setup time, the second next connection setup time, and a current time.

7. The apparatus of claim 6, wherein the first inter-connection setup time and the second inter-connection setup time are calculated using a predictive algorithm.

8. The apparatus of claim 1, wherein the at least one processor is further configured to:
determine a first interval;
calculate a first inter-connection setup time for a first PDU session of the two or more PDU sessions based on a first quantity of the connection setup events associated with the first PDU session and occurring during the first interval;
estimate a first next connection setup time for the first PDU session based on the first inter-connection setup time and a last first PDU session connection setup time;
estimate a second next connection setup time for a second PDU session based on a second inter-connection setup time for the second PDU session and a last second PDU session connection setup time; and
select the first PDU session or the second PDU session as the next active PDU session based on the first next connection setup time, the second next connection setup time, and a current time of day.

9. The apparatus of claim 8, wherein the first inter-connection setup time and the second inter-connection setup time are calculated using a predictive algorithm.

10. The apparatus of claim 1, wherein the at least one processor is further configured to:
calculate a first average inter-connection time for a first PDU session of the two or more PDU sessions based on a first quantity of the connection setup events associated with the first PDU session over the period;
estimate a first next connection setup time for the first PDU session based on the first average inter-connection time and a last first PDU session connection setup time;
estimate a second next connection setup time for a second PDU session based on a second average inter-connection time for the second PDU session and a last second PDU session connection setup time; and
select the first PDU session or the second PDU session as the next active PDU session based on the first next connection setup time, the second next connection setup time, and a current time of day.

11. The apparatus of claim 1, further comprising a transceiver coupled to the at least one processor.

12. A method of wireless communication at a user equipment (UE), comprising:
predicting a next active protocol data unit (PDU) session of two or more PDU sessions based on next connection setup times for each PDU session, the next connection setup times estimated based on connection setup events occurring over a period; and
selecting a frequency channel to camp on based on the next active PDU session.

13. The method of claim 12, further comprising:
switching to the frequency channel while operating in an inactive mode or an idle mode when a current frequency channel is different than the frequency channel.

14. The method of claim 12, further comprising:
receiving network slice information indicating a priority of each frequency channel of a set of frequency channels associated with one or more network slices, and wherein each PDU session of the two or more PDU sessions is associated with a respective network slice and a respective frequency channel based on the network slice information.

15. The method of claim 12, further comprising:
identifying a first next connection setup time of the next connection setup times, the first next connection setup time associated with a first PDU session of the two or more PDU sessions;
identifying a second next connection setup time of the next connection setup times, the second next connection setup time associated with a second PDU session of the two or more PDU sessions, the first next connection setup time occurring earlier than the second next connection setup time in a time domain; and
selecting the second PDU session as the next active PDU session when a difference between the first next connection setup time and the second next connection setup time satisfies a delta threshold, and a first priority of a first network slice associated with the first PDU session is lower than a second priority of a second network slice associated with the second PDU session.

16. The method of claim 12, wherein the UE predicts the next active PDU session at least one of after performing a connection release, after performing a cell change, or periodically.

17. The method of claim 12, further comprising:
calculating a first inter-connection setup time for a first PDU session of the two or more PDU sessions based on a subset of the connection setup events, the subset of the connection setup events including a time sequence of each connection setup event associated with the first PDU session over the period;
estimating a first next connection setup time for the first PDU session based on the first inter-connection setup time for the first PDU session and a last first PDU session connection setup time;
estimating a second next connection setup time for a second PDU session based on a second inter-connection setup time for the second PDU session and a last second PDU session connection setup time; and
selecting the first PDU session or the second PDU session as the next active PDU session based on the first next connection setup time, the second next connection setup time, and a current time.

18. The method of claim 17, wherein the first inter-connection setup time and the second inter-connection setup time are calculated using a predictive algorithm.

19. The method of claim 12, further comprising:
determining a first interval;
calculating a first inter-connection setup time for a first PDU session of the two or more PDU sessions based on a first quantity of the connection setup events associated with the first PDU session and occurring during the first interval;
estimating a first next connection setup time for the first PDU session based on the first inter-connection setup time and a last first PDU session connection setup time;
estimating a second next connection setup time for a second PDU session based on a second inter-connection setup time for the second PDU session and a last second PDU session connection setup time; and
selecting the first PDU session or the second PDU session as the next active PDU session based on the first next connection setup time, the second next connection setup time, and a current time of day.

20. The method of claim 19, wherein the first inter-connection setup time and the second inter-connection setup time are calculated using a predictive algorithm.

21. The method of claim 12, further comprising:
calculating a first average inter-connection time for a first PDU session of the two or more PDU sessions based on a first quantity of the connection setup events associated with the first PDU session over the period;
estimating a first next connection setup time for the first PDU session based on the first average inter-connection time and a last first PDU session connection setup time;
estimating a second next connection setup time for a second PDU session based on a second average inter-connection time for the second PDU session and a last second PDU session connection setup time; and
selecting the first PDU session or the second PDU session as the next active PDU session based on the first next connection setup time, the second next connection setup time, and a current time of day.

22. An apparatus for wireless communication at a user equipment (UE), comprising:
means for predicting a next active protocol data unit (PDU) session of two or more PDU sessions based on next connection setup times for each PDU session, the next connection setup times estimated based on connection setup events occurring over a period; and
means for selecting a frequency channel to camp on based on the next active PDU session.

23. The apparatus of claim 22, further comprising:
means for identifying a first next connection setup time of the next connection setup times, the first next connection setup time associated with a first PDU session of the two or more PDU sessions;
means for identifying a second next connection setup time of the next connection setup times, the second next connection setup time associated with a second PDU session of the two or more PDU sessions, the first next connection setup time occurring earlier than the second next connection setup time in a time domain; and
means for selecting the second PDU session as the next active PDU session when a difference between the first next connection setup time and the second next connection setup time satisfies a delta threshold, and a first priority of a first network slice associated with the first PDU session is lower than a second priority of a second network slice associated with the second PDU session.

24. The apparatus of claim 22, further comprising:
means for calculating a first inter-connection setup time for a first PDU session of the two or more PDU sessions based on a subset of the connection setup events, the subset of the connection setup events including a time sequence of each connection setup event associated with the first PDU session over the period;
means for estimating a first next connection setup time for the first PDU session based on the first inter-connection setup time for the first PDU session and a last first PDU session connection setup time;
means for estimating a second next connection setup time for a second PDU session based on a second inter-connection setup time for the second PDU session and a last second PDU session connection setup time; and
means for selecting the first PDU session or the second PDU session as the next active PDU session based on the first next connection setup time, the second next connection setup time, and a current time.

25. The apparatus of claim 22, further comprising:
means for determining a first interval;
means for calculating a first inter-connection setup time for a first PDU session of the two or more PDU sessions based on a first quantity of the connection setup events associated with the first PDU session and occurring during the first interval;
means for estimating a first next connection setup time for the first PDU session based on the first inter-connection setup time and a last first PDU session connection setup time;
means for estimating a second next connection setup time for a second PDU session based on a second inter-connection setup time for the second PDU session and a last second PDU session connection setup time; and
means for selecting the first PDU session or the second PDU session as the next active PDU session based on the first next connection setup time, the second next connection setup time, and a current time of day.

26. The apparatus of claim 22, further comprising:
means for calculating a first average inter-connection time for a first PDU session of the two or more PDU sessions based on a first quantity of the connection setup events associated with the first PDU session over the period;
means for estimating a first next connection setup time for the first PDU session based on the first average inter-connection time and a last first PDU session connection setup time;
means for estimating estimate a second next connection setup time for a second PDU session based on a second average inter-connection time for the second PDU session and a last second PDU session connection setup time; and
means for select the first PDU session or the second PDU session as the next active PDU session based on the first next connection setup time, the second next connection setup time, and a current time of day.

27. A computer-readable medium storing computer executable code at a user equipment (UE), the computer executable code, when executed, causes a processor to:
predict a next active protocol data unit (PDU) session of two or more PDU sessions based on next connection setup times for each PDU session, the next connection setup times estimated based on connection setup events occurring over a period; and
select a frequency channel to camp on based on the next active PDU session.

28. The computer-readable medium of claim 27, wherein the computer executable code, when executed, further causes the processor to:
calculate a first inter-connection setup time for a first PDU session of the two or more PDU sessions based on a subset of the connection setup events, the subset of the connection setup events including a time sequence of each connection setup event associated with the first PDU session over the period;
estimate a first next connection setup time for the first PDU session based on the first inter-connection setup time for the first PDU session and a last first PDU session connection setup time;
estimate a second next connection setup time for a second PDU session based on a second inter-connection setup time for the second PDU session and a last second PDU session connection setup time; and
select the first PDU session or the second PDU session as the next active PDU session based on the first next connection setup time, the second next connection setup time, and a current time.

29. The computer-readable medium of claim 27, wherein the computer executable code, when executed, further causes the processor to:
determine a first interval;
calculate a first inter-connection setup time for a first PDU session of the two or more PDU sessions based on a first quantity of the connection setup events associated with the first PDU session and occurring during the first interval;
estimate a first next connection setup time for the first PDU session based on the first inter-connection setup time and a last first PDU session connection setup time;
estimate a second next connection setup time for a second PDU session based on a second inter-connection setup time for the second PDU session and a last second PDU session connection setup time; and
select the first PDU session or the second PDU session as the next active PDU session based on the first next connection setup time, the second next connection setup time, and a current time of day.

30. The computer-readable medium of claim 27, wherein the computer executable code, when executed, further causes the processor to:
calculate a first average inter-connection time for a first PDU session of the two or more PDU sessions based on a first quantity of the connection setup events associated with the first PDU session over the period;
estimate a first next connection setup time for the first PDU session based on the first average inter-connection time and a last first PDU session connection setup time;
estimate a second next connection setup time for a second PDU session based on a second average inter-connection time for the second PDU session and a last second PDU session connection setup time; and
select the first PDU session or the second PDU session as the next active PDU session based on the first next connection setup time, the second next connection setup time, and a current time of day.
